(19) United States
(12) Patent Application Publication
(10) Pub. No.: US 2024/0103943 A1
(43) Pub. Date: Mar. 28, 2024

(54) Dynamic Control of Message Expiry by Messaging Middleware

(71) Applicant: International Business Machines Corporation, Armonk, NY (US)

(72) Inventors: Amar Shah, Pune (IN); Venkata Kiran Kumar Darbha, Hyderabad (IN)

(21) Appl. No.: 17/935,199

(22) Filed: Sep. 26, 2022

(51) Int. Cl. G06F 9/54; H04L 69/22

(52) U.S. Cl. CPC G06F 9/546; H04L 69/22

(57) ABSTRACT

Dynamically controlling message expiry is provided. A message located in a message queue that has an expiry value and a dynamic expiry value set by a message producer in a header of the message is tracked. It is determined that the message is eligible for extension of the expiry value based on the dynamic expiry value being set to a particular value. An amount of time before a message consumer can process the message is determined based on one or more factors. The expiry value of the message is extended to form an extended expiry value in response to determining that the message is likely to expire in the message queue prior to the message consumer processing the message based on the one or more factors.

### BACKGROUND

### 1. Field

The disclosure relates generally to message processing and more specifically to dynamically controlling message expiry in a message queue managed by a messaging server.

### 2. Description of the Related Art

In message-oriented middleware system (e.g., a message queuing system), “message expiry” is a property of a message that indicates a lifespan of that message. The message queuing system enables message producers and message consumers to interact asynchronously via message queues managed by the message queuing system. Message expiry is set in terms of time. In other words, message expiry defines the end of the period of time for which a message is valid. For example, after the set expiry time, if the message is not consumed by the message consumer, the message queuing system expires the message and removes the message from the message queue.

Message expiry is used for various reasons, such as, for example, a particular message (e.g., a transaction, an event, or the like) is meaningful to an entity, such as, for example, an enterprise, business, company, organization, institution, agency, or the like, only for a certain period of time, after which, the message becomes irrelevant or loses context for the entity. Message expiry values help the message queuing system to be more resilient as unconsumed messages with no expiry value can accumulate in the message queue and decrease performance of the message queuing system (e.g., the messaging server).

### SUMMARY

According to one illustrative embodiment, a computer-implemented method for dynamically controlling message expiry is provided. A computer tracks a message located in a message queue that has an expiry value and a dynamic expiry value set by a message producer in a header of the message. The computer determines that the message is eligible for extension of the expiry value based on the dynamic expiry value being set to a particular value. The computer determines an amount of time before a message consumer can process the message based on one or more factors. The computer extends the expiry value of the message to form an extended expiry value in response to determining that the message is likely to expire in the message queue prior to the message consumer processing the message based on the one or more factors. According to other illustrative embodiments, a computer system and computer program product for dynamically controlling message expiry are provided.

### BRIEF DESCRIPTION OF THE DRAWINGS

FIG. 1 is a pictorial representation of a computing environment in which illustrative embodiments may be implemented;

FIG. 2 is a diagram illustrating an example of a message expiry management system in accordance with an illustrative embodiment;

FIG. 3 is a diagram illustrating an example of a message expiry management process for high queue depth in accordance with an illustrative embodiment;

FIG. 4 is a diagram illustrating an example of a message expiry management process for low queue depth with large average message size in accordance with an illustrative embodiment;

FIG. 5 is a diagram illustrating an example of a message expiry management process for higher priority messages positioned later in a message queue in accordance with an illustrative embodiment;

FIG. 6 is a diagram illustrating an example of a message expiry management process for a message header dynamic expiry field set to zero in accordance with an illustrative embodiment;

FIG. 7 is a flowchart illustrating a process for generating a message with a message expiry value and a dynamic expiry value in accordance with an illustrative embodiment;

FIGS. 8A-8B are a flowchart illustrating a process for determining a message extended expiry value in accordance with an illustrative embodiment; and

FIG. 9 is a flowchart illustrating a process for extending an expiry value of a message in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

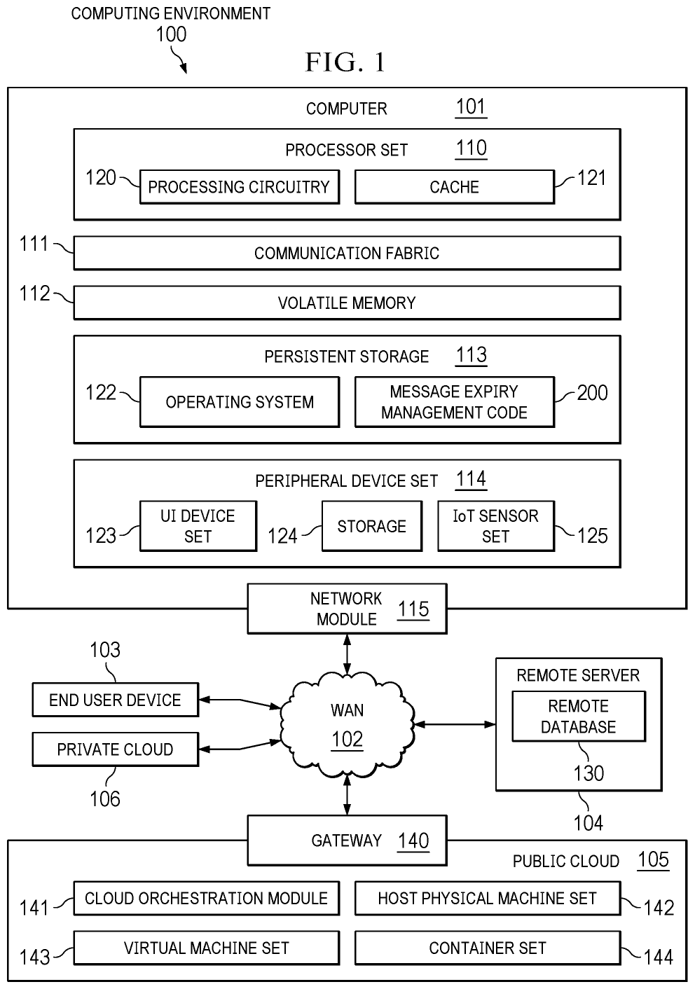

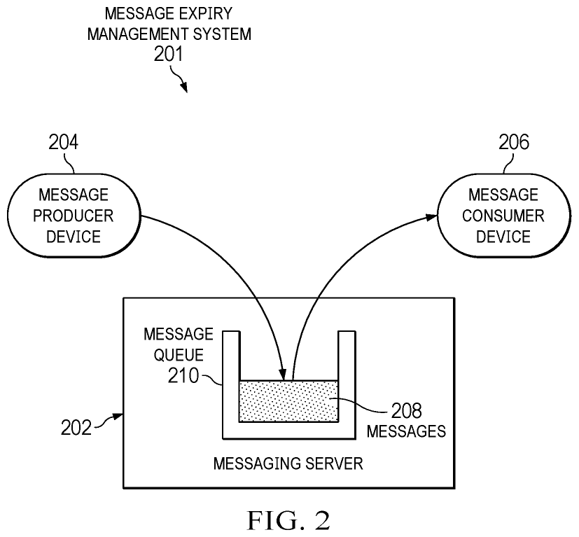

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as message expiry management code 200. Both message producer and message consumer are actively producing and consuming messages, respectively, especially for an entity that is running a message, transaction, or event-driven application. Message expiry management code 200 determines existing expiry date and time of each respective message in a set of message queues managed by computer 101. Message expiry management code 200 extends (i.e., increases) the expiry value of a given message that is likely to expire in a message queue prior to being processed by the message consumer. Message expiry management code 200 dynamically and intelligently extends the expiry value of the message based on a plurality of different factors. Message expiry management code 200 extends the expiry value on all eligible messages so that there is an increased likelihood of successful processing of all messages in the message queue by the message consumer.

In addition to message expiry management code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and message expiry management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in message expiry management code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The message expiry management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Message expiry enables message producers to set a lifespan of a message containing time sensitive information, such as, for example, business transaction information, which is expected to be valid only for certain period of time. Message expiry helps the message queuing system (i.e., the messaging server) by enabling the message queuing system to remove expired or obsolete messages. Currently, message producers often fix message expiry arbitrarily. For example, a message producer may set the expiry value of a message at 5 seconds, 3 minutes, 2 hours, 1 day, or the like.

However, the message producer may not have complete knowledge of the current state in which the messaging server or the message consumer is operating in order for the message producer to determine an appropriate expiry value for the message. As a result, the message producer may set the message expiry value too low leading to the message expiring in the message queue before the message consumer has an opportunity to process the message. When a message with important information expires within the message queue prior to processing, it negatively impacts an entity, such as, for example, a bank, retailer, or the like, due to the reprocessing of such messages and the reconciling of failed transactions. Increasing the message expiry by some random value is not practicable because the information contained in the message can be time sensitive.

Generally, a message consumer processes messages in a message queue in First In First Out (FIFO) order or based on the priority of given messages. As an illustrative example, a message queue has a depth of 10,000 messages. Of these 10,000 messages, 9,000 messages have no expiry value set (i.e., will not expire) and the remaining 1,000 messages have some expiry value set. Assume 500 messages of those 1,000 messages have an expiry value set with a long expiry duration and the other 500 messages have a short expiry duration. Long expiry duration and short expiry duration are relative to the current time. In other words, long expiry means messages having fairly long expiry duration as compared to other messages that will expire sooner. Also, assume that the 9,000 messages having no expiry values are in the message queue ahead of the 1,000 messages with expiry values. In such a situation, a possibility exists that by the time the message consumer finishes processing the first 9,000 messages in the message queue, some of the 1,000 messages remaining in the message queue (i.e., one or more of messages 9,001-10,000) may have expired because the time taken by the message consumer to process the first 9,000 messages in FIFO order exceeded the expiry value set for those particular messages.

Assume that the message consumer application is designed to process messages fast enough to keep up with the incoming message load. However, events occur, such as, for example, environmental factors, external services, unplanned issues, or the like, which affect the message consumer application's processing speed, leading to slower removal of messages from the message queue. As a result, messages with short expiry, placed deep in the message queue, can expire and be removed from the message queue prior to the message consumer application processing these messages.

One current message processing solution merely adds more message consumer application instances so that more messages can be processed from the message queue in parallel. However, adding more message consumer application instances to manage message processing slowness, which is intermittent and unpredictable, is not ideal. For example, adding more message consumer application instances means utilizing more system resources, such as, for example, increasing CPU, memory, and storage utilization, which incurs additional costs for which no system benefits would be realized most of the time.

Another current message processing solution just increases the priority of messages that are set to expire relatively soon. However, increasing the priority of messages soon to expire will not work for messages that are already set at the highest priority level. Moreover, the priority field set on a message header may be for a particular reason, such as, for example, to identify a given message as in a certain message class for business logic routing. Consequently, increasing the priority of such a message may cause the business logic to incorrectly handle that message.

Illustrative embodiments take into account and address the issues with these current message processing solutions mentioned above for messages having expiry values set by the message producer application. Illustrative embodiments dynamically extend or increase expiry values of certain messages by taking into account a plurality of different factors, such as, for example, message queue depth, position of given messages within the message queue, message processing speed (e.g., number of messages processed per second) of the message consumer application, standard deviation (e.g., amount of deviation from the mean of the message processing speed), size of messages, put and get rates in and out of the message queue, priority of given messages, and the like, to enable successful message processing by the message consumer application rather than having messages expire within the message queue due to not being processed by the message consumer application prior to expiry of given messages.

Standard deviation is a value that illustrative embodiments calculate to determine true message processing speed of the message consumer at that point in time. The message processing speed parameter of the message consumer application is an average value over a configurable period of time. However, the message processing speed parameter may not be the true speed at the time of calculating the message expiry value extension. As a result, illustrative embodiments determine any delta (i.e., standard deviation) that should be added to the derived message expiry value extension. For determining the standard deviation value, illustrative embodiments can utilize, for example, a machine learning model, a statistical model, or the like that takes into account the historical message processing speed along with associated parameters, such as time of day, message sizes, and the like, and the current processing speed at more granular time periods. For example, illustrative embodiments recalculate the message processing speed of the message consumer application at a configurable time interval, such as every 20 seconds, every minute, once an hour, once a day, or the like, to adjust the standard deviation value. Alternatively, illustrative embodiments can recalculate the message processing speed on demand.

Illustrative embodiments determine the optimal value for increasing the expiry of given messages, as well as determine which messages need message expiry extension (i.e., increase) and which messages can remain with their originally set expiry values. In other words, illustrative embodiments extend the expiry value of only those messages that are at risk of expiring in the message queue prior to the message consumer application being able to process those messages. Illustrative embodiments add a new Boolean field (i.e., a “DynamicExpiry” field) within the message header, which indicates whether a given message is eligible for message expiry extension or not. The message producer application (i.e., the application that generates the message and places the message in the message queue) sets the value in the DynamicExpiry field. If the message producer application sets the value of the DynamicExpiry field to “1,” which indicates that the expiry value of that particular message can be extended or increased, then illustrative embodiments determine whether to extend the expiry value of that particular message based on the plurality of different factors. Conversely, if the message producer application sets the value of the DynamicExpiry field to “0,” then the messaging server knows that the expiry value of that particular message is not to be extended from what was originally set by the message producer application. However, it should be noted that according to alternative illustrative embodiments, the message producer application can set the value of the DynamicExpiry field to “true” or “false” instead of 1 or 0, respectively.

In addition, it should be noted that different messages can have different expiry values and the different expiry values depend on the message producer applications and business logic. As a result, in a message queue that is shared by multiple message producer applications, messages that are closer to their expiry value (e.g., messages with a shorter expiry) can exist in the message queue along with messages that have a greater expiry value (e.g., messages with a longer expiry). In response to illustrative embodiments identifying certain messages in the message queue that have relatively short expiry and these same messages are deep down in the message queue and have their DynamicExpiry field set to 1, then illustrative embodiments extend the expiry value of those messages when needed based on the plurality of different factors. Moreover, in response to illustrative embodiments determining that a message already having an extended expiry value is likely to expire within the message queue and is still not processed by the message consumer application prior to expiration of the extended expiry value, then illustrative embodiments determine a new expiry extension value for that message.

Thus, illustrative embodiments increase the likelihood that messages (e.g., business transactions) are successfully processed by the message consumer application which otherwise may have failed due to untimely expiry in the message queue. Further, illustrative embodiments improve the message producer application performance such that the message producer application is less likely to resend messages that expired in the message queue and, therefore, reduce network traffic.

Accordingly, illustrative embodiments provide one or more technical solutions that overcome a technical problem with messages expiring in message queues prior to message consumer applications processing those messages. As a result, these one or more technical solutions provide a technical effect and practical application in the field of message processing.

With reference now to FIG. 2, a diagram illustrating an example of a message expiry management system is depicted in accordance with an illustrative embodiment. Message expiry management system 201 may be implemented in a computing environment, such as computing environment 100 in FIG. 1. Message expiry management system 201 is a system of hardware and software components for dynamically and intelligently controlling message expiry in a message queue.

In this example, message expiry management system 201 includes messaging server 202, message producer device 204, and message consumer device 206. Messaging server 202 may be, for example, computer 101 in FIG. 1. Message producer device 204 and message consumer device 206 each represent a client device, such as, for example, EUD 103 in FIG. 1, corresponding to messaging server 202. However, it should be noted that message expiry management system 201 is intended as an example only and not as a limitation on illustrative embodiments. In other words, message expiry management system 201 may include any number of messaging servers, message producer devices, message consumer devices, and other devices and components not shown.

Message producer device 204, using a message producer application, generates messages 208 and sends messages 208 to messaging server 202. Messaging server 202 places messages 208 in message queue 210 of messaging server 202. It should be noted that the message producer application may set a message expiry value in a header of a set of messages of messages 208 based on a set of predefined messaging rules. Further, the message producer application may set a DynamicExpiry value in the header of a subset of messages of the set of messages having a message expiry value set based on the set of messaging rules. The DynamicExpiry value indicates to messaging server 202 whether a particular message is eligible for extension of the original expiry value set for that particular message by the message producer application. Messaging server 202 generates a ranked list of messages located in message queue 210 in ascending order based on expiry values of the set of messages having message expiry values set in their headers. Message consumer device 206, utilizing a message consumer application, consumes and processes messages 208 out of message queue 210 based on the ranked list of messages.

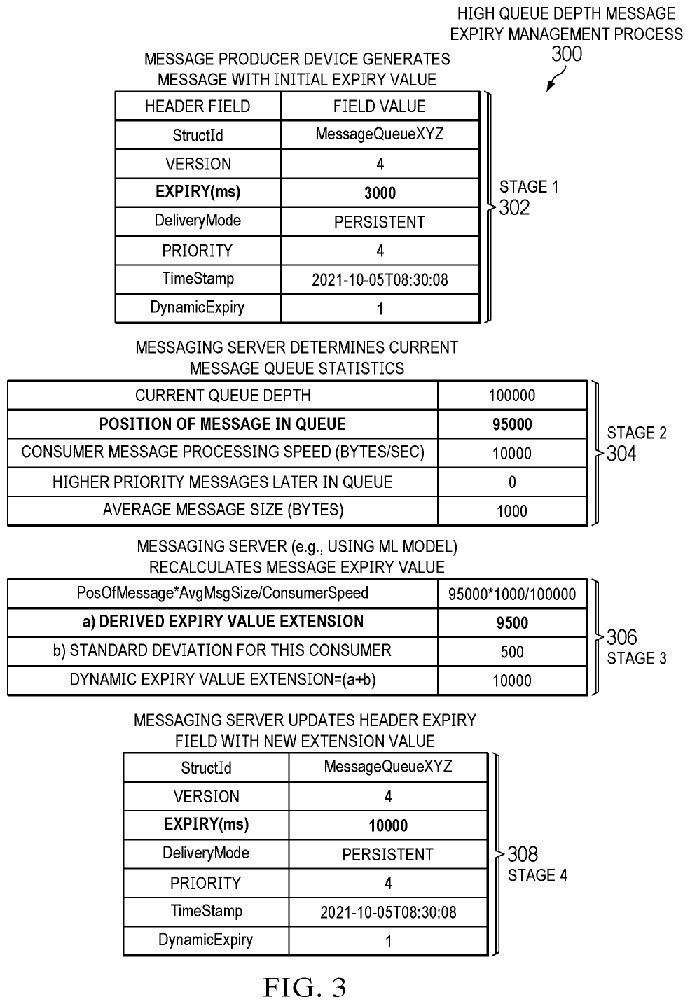

With reference now to FIG. 3, a diagram illustrating an example of a message expiry management process for high queue depth is depicted in accordance with an illustrative embodiment. High queue depth message expiry management process 300 may be implemented in a message expiry management system, such as, for example, message expiry management system 201 in FIG. 2.

In this example, high queue depth message expiry management process 300 includes stage 1 302, stage 2 304, stage 3 306, and stage 4 308. At stage 1 302, a message producer device, such as, for example, message producer device 204 in FIG. 2, generates a message with an initial expiry value (e.g., 3000 milliseconds (ms)), a priority level (e.g., 4), and a DynamicExpiry value (e.g., 1) that indicates eligibility for extension of the initial expiry value. At stage 2 304, a messaging server, such as, for example, messaging server 202 in FIG. 2, determines current statistics of a message queue, such as, for example, message queue 210 in FIG. 2. In this example, the current message queue statistics are: current queue depth is 100000; position of the message, which was generated in state 1 302, within the message queue is 95000; processing speed of a message consumer, such as, for example, message consumer device 206 in FIG. 2, is 10000 messages per second; higher priority messages later in queue is 0; and average message size is 1000 bytes.

At stage 3 306, the messaging server, using for example a machine learning model, statistical model, or the like, recalculates the message expiry value of the message generated in step 1 302. For example, the messaging server multiples the position of the message in the queue by the average message size and then divides that product by the processing speed of the message consumer to generate a derived expiry value extension for the message (e.g., 95000*1000/100000=9500). The messaging server also calculates a standard deviation value for the message consumer at this point in time (e.g., 500). Afterward, the messaging server adds standard deviation value to the derived expiry value extension to generate a dynamic expiry value extension for the message (e.g., 9500+500=10000).

At stage 4 308, the messaging server updates the expiry field in the header of the message generated in stage 1 302 with the new dynamic expiry value extension. For example, the messaging server replaces the initial expiry value of 3000 in the header of the message with the new dynamic expiry value extension of 10000. As a result, the message now has an extended lifespan in the message queue. Consequently, the message is not likely to expire in the message queue prior to the message consumer being able to process that message.

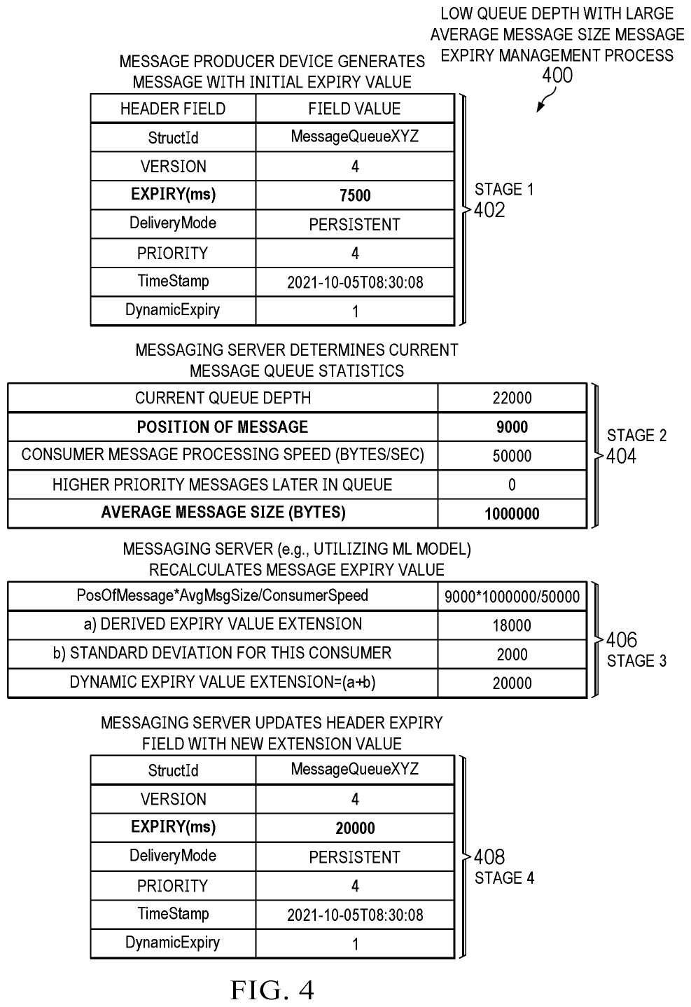

With reference now to FIG. 4, a diagram illustrating an example of a message expiry management process for low queue depth with large average message size is depicted in accordance with an illustrative embodiment. Low queue depth with large average message size message expiry management process 400 may be implemented in a message expiry management system, such as, for example, message expiry management system 201 in FIG. 2.

In this example, low queue depth with large average message size message expiry management process 400 includes stage 1 402, stage 2 404, stage 3 406, and stage 4 408, such as, for example, stage 1 302, stage 2 304, stage 3 306, and stage 4 308 in FIG. 3. At stage 1 402, the message producer device generates a message with an initial expiry value (e.g., 7500 ms), a priority level (e.g., 4), and a DynamicExpiry value (e.g., 1) that indicates eligibility for extension of the initial expiry value. At stage 2 404, the messaging server determines the current statistics of the message queue. In this example, the current message queue statistics are: current queue depth is 22000; position of the message, which was generated in state 1 402, within the message queue is 9000; processing speed of the message consumer is 50000 messages per second; higher priority messages later in queue is 0; and average message size is 1000000 bytes.

At stage 3 406, the messaging server recalculates the message expiry value of the message generated in step 1 402. For example, the messaging server multiples the position of the message in the queue by the average message size and then divides that product by the processing speed of the message consumer to generate a derived expiry value extension for the message (e.g., 9000*1000000/50000=18000). The messaging server also calculates a standard deviation value for the message consumer at this point in time (e.g., 2000). Afterward, the messaging server adds standard deviation value to the derived expiry value extension to generate a dynamic expiry value extension for the message (e.g., 18000+2000=20000).

At stage 4 408, the messaging server updates the expiry field in the header of the message generated in stage 1 402 with the new dynamic expiry value extension. For example, the messaging server replaces the initial expiry value of 7500 in the header of the message with the new dynamic expiry value extension of 20000. As a result, the message now has an extended lifespan in the message queue. Consequently, the message is not likely to expire in the message queue prior to the message consumer being able to process that message.

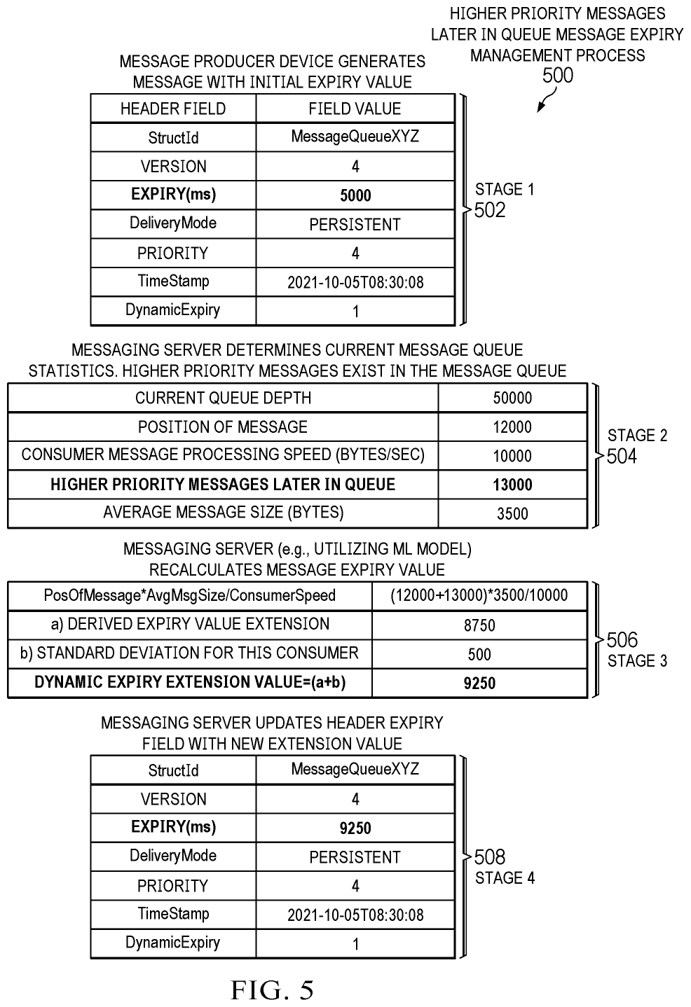

With reference now to FIG. 5, a diagram illustrating an example of a message expiry management process for higher priority messages positioned later in a message queue is depicted in accordance with an illustrative embodiment. Higher priority messages later in queue message expiry management process 500 may be implemented in a message expiry management system, such as, for example, message expiry management system 201 in FIG. 2.

In this example, higher priority messages later in queue message expiry management process 500 includes stage 1 502, stage 2 504, stage 3 506, and stage 4 508, such as, for example, stage 1 402, stage 2 404, stage 3 406, and stage 4 408 in FIG. 4. At stage 1 502, the message producer device generates a message with an initial expiry value (e.g., 5000 ms), a priority level (e.g., 4), and a DynamicExpiry value (e.g., 1) that indicates eligibility for extension of the initial expiry value. At stage 2 504, the messaging server determines the current statistics of the message queue. It should be noted that higher priority messages exist in the message queue (e.g., messages having a priority level greater than 4). In this example, the current message queue statistics are: current queue depth is 50000; position of the message, which was generated in state 1 502, within the message queue is 12000; processing speed of the message consumer is 10000 messages per second; higher priority messages positioned later in the message queue is 13000; and average message size is 3500 bytes.

At stage 3 506, the messaging server recalculates the message expiry value of the message generated in step 1 502. For example, the messaging server first adds the position of the message in the queue and the number of higher priority messages positioned later in the message queue after the message, then multiples that sum by the average message size, and then divides that product by the processing speed of the message consumer to generate a derived expiry value extension for the message (e.g., (12000+13000)*3500/10000=8750). The messaging server also calculates a standard deviation value for the message consumer at this point in time (e.g., 500). Afterward, the messaging server adds standard deviation value to the derived expiry value extension to generate a dynamic expiry value extension for the message (e.g., 8750+500=9250).

At stage 4 508, the messaging server updates the expiry field in the header of the message generated in stage 1 502 with the new dynamic expiry value extension. For example, the messaging server replaces the initial expiry value of 5000 in the header of the message with the new dynamic expiry value extension of 9250. As a result, the message now has an extended lifespan in the message queue. Consequently, the message is not likely to expire in the message queue prior to the message consumer being able to process that message.

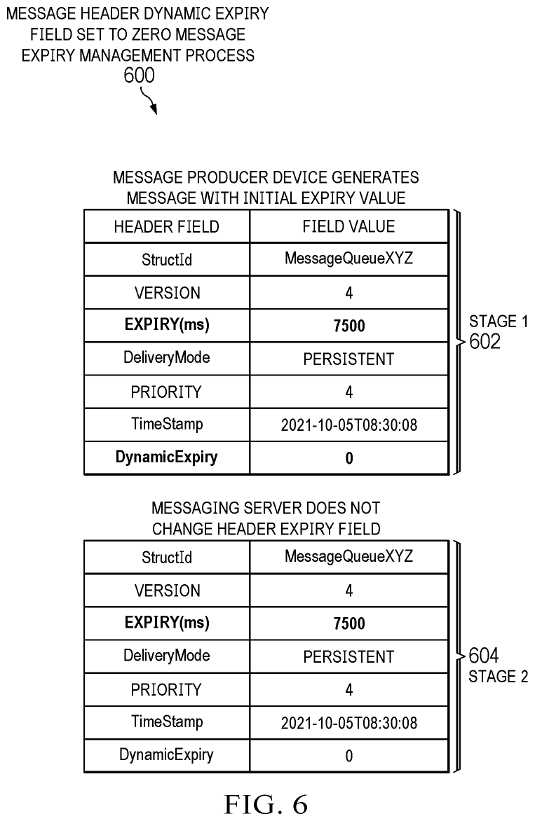

With reference now to FIG. 6, a diagram illustrating an example of a message expiry management process for a message header dynamic expiry field set to zero is depicted in accordance with an illustrative embodiment. Message header dynamic expiry field set to zero message expiry management process 600 may be implemented in a message expiry management system, such as, for example, message expiry management system 201 in FIG. 2.

In this example, message header dynamic expiry field set to zero message expiry management process 600 includes stage 1 602 and stage 2 604. At stage 1 602, the message producer device generates a message with an initial expiry value (e.g., 7500 ms), a priority level (e.g., 4), and a DynamicExpiry value of 0 indicating that the message is not eligible for extension of the initial expiry value. At stage 2 604, in response to the DynamicExpiry value being set to 0 in the message header, the messaging server does not change the message expiry value of 7500 ms in that header field.

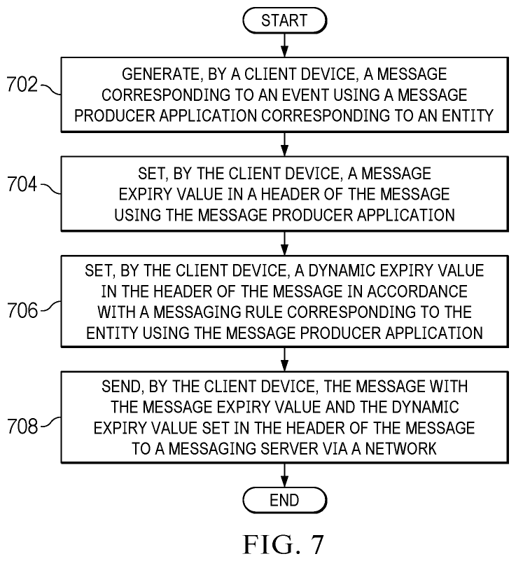

With reference now to FIG. 7, a flowchart illustrating a process for generating a message with a message expiry value and a dynamic expiry value is shown in accordance with an illustrative embodiment. The process shown in FIG. 7 may be implemented in a client device, such as, for example, EUD 103 in FIG. 1 or message producer device 204 in FIG. 2.

The process begins when the client device generates a message corresponding to an event using a message producer application corresponding to an entity (step 702). The event may be, for example, a transaction. The entity may be, for example, a bank, a retailer, a business, a company, a financial institution, a healthcare organization, educational institution, government agency, or the like.

In response to generating the message, the client device, using the message producer application, sets a message expiry value in a header of the message (step 704). In addition, the client device, using the message producer application, sets a dynamic expiry value in a header of the message in accordance with a messaging rule corresponding to the entity (step 706).

Afterward, the client device sends the message with the message expiry value and the dynamic expiry value set in the header of the message to a messaging server via a network (step 708). The messaging server may be, for example, computer 101 in FIG. 1 or messaging server 202 in FIG. 2. Thereafter, the process terminates.

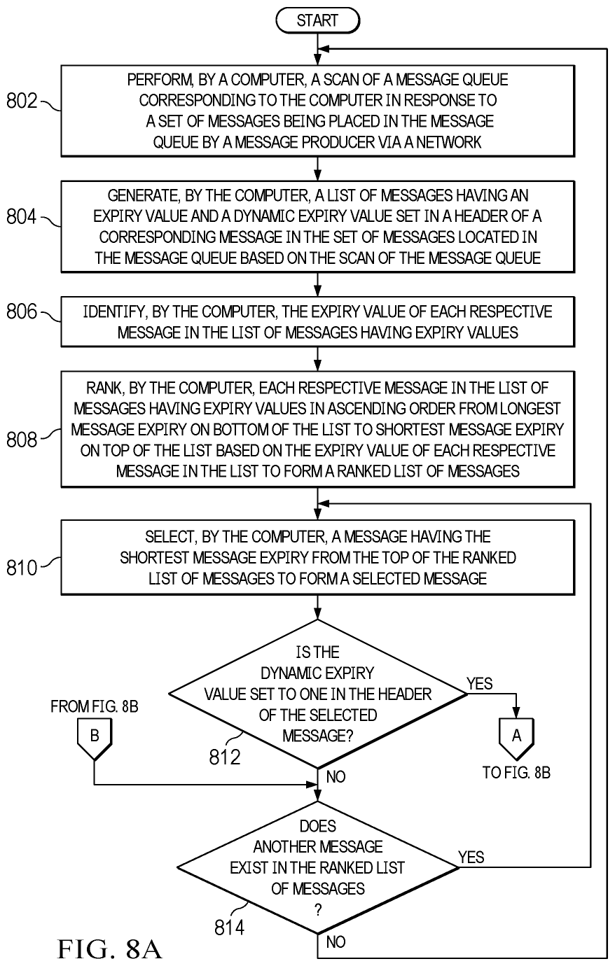

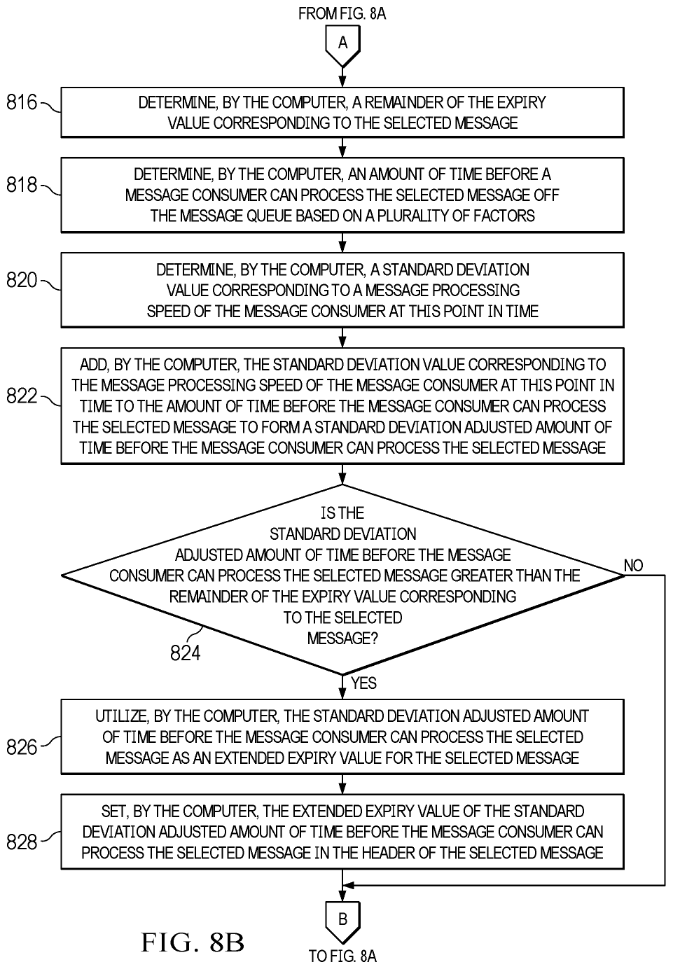

With reference now to FIGS. 8A-8B, a flowchart illustrating a process for determining a message extended expiry value is shown in accordance with an illustrative embodiment. The process shown in FIGS. 8A-8B may be implemented in a computer, such as, for example, computer 101 in FIG. 1 or messaging server 202 in FIG. 2. For example, the process shown in FIGS. 8A-8B may be implemented in message expiry management code 200 in FIG. 1.

The process begins when the computer performs a scan of a message queue corresponding to the computer in response to a set of messages being placed in the message queue by a message producer via a network (step 802). The message queue may be, for example, message queue 210 in FIG. 2. The set of messages may be, for example, messages 208 in FIG. 2. The message producer may be, for example, EUD 103 in FIG. 1 or message producer device 204 in FIG. 2. The network may be, for example, WAN 102 in FIG. 1.

Afterward, the computer generates a list of messages having an expiry value and a dynamic expiry value set in a header of a corresponding message in the set of messages located in the message queue based on the scan of the message queue (step 804). In addition, the computer identifies the expiry value of each respective message in the list of messages having expiry values (step 806). Further, the computer ranks each respective message in the list of messages having expiry values in ascending order from longest message expiry on bottom of the list to shortest message expiry on top of the list based on the expiry value of each respective message in the list to form a ranked list of messages (step 808).

Subsequently, the computer selects a message having the shortest message expiry from the top of the ranked list of messages to form a selected message (step 810). The computer makes a determination as to whether the dynamic expiry value is set to one (1) in the header of the selected message (step 812). If the computer determines that the dynamic expiry value is not set to one (e.g., set to zero (0)) in the header of the selected message, no output of step 812, then the computer makes a determination as to whether another message exists in the ranked list of messages (step 814).

If the computer determines that another message does exist in the ranked list of messages, yes output of step 814, then the process returns to step 810 where the computer selects a message having the next shortest message expiry from the ranked list of messages. If the computer determines that another message does not exist in the ranked list of messages, no output of step 814, then the process returns to step 802 where the computer waits to perform a scan of the message queue in response to another set of messages being placed in the message queue.

Returning again to step 812, if the computer determines that the dynamic expiry value is set to one in the header of the selected message, yes output of step 812, then the computer determines a remainder of the expiry value corresponding to the selected message (step 816). Furthermore, the computer determines an amount of time before a message consumer can process the selected message off the message queue based on a plurality of factors (step 818). The message consumer may be, for example, message consumer device 206 in FIG. 2. The plurality of factors includes, for example, at least one of message queue depth (i.e., number of messages in the message queue), position of each respective message within the message queue, message consumer message processing speed (i.e., number of messages processed per second by the message consumer), standard deviation (e.g., amount of deviation from the mean of the message processing speed corresponding to the message consumer at this point in time), average size of messages in the message queue, put and get rates in and out of the message queue, set priority level of each respective message in the message queue, and the like. Moreover, the computer determines a standard deviation value corresponding to a message processing speed of the message consumer at this point in time (step 820).

Afterward, the computer adds the standard deviation value corresponding to the message processing speed of the message consumer at this point in time to the amount of time before the message consumer can process the selected message to form a standard deviation adjusted amount of time before the message consumer can process the selected message (step 822). The computer makes a determination as to whether the standard deviation adjusted amount of time before the message consumer can process the selected message is greater than the remainder of the expiry value corresponding to the selected message (step 824).

If the computer determines that the standard deviation adjusted amount of time before the message consumer can process the selected message is not greater than (e.g., is less than or equal to) the remainder of the expiry value corresponding to the selected message, no output of step 824, then the process returns to step 814 where the computer determines whether another message exists in the ranked list of messages. If the computer determines that the standard deviation adjusted amount of time before the message consumer can process the selected message is greater than the remainder of the expiry value corresponding to the selected message, yes output of step 824, then the computer utilizes the standard deviation adjusted amount of time before the message consumer can process the selected message as an extended expiry value for the selected message (step 826). In addition, the computer sets the extended expiry value of the standard deviation adjusted amount of time before the message consumer can process the selected message in the header of the selected message (step 828). Thereafter, the process returns to step 814 where the computer determines whether another message exists in the ranked list of messages.

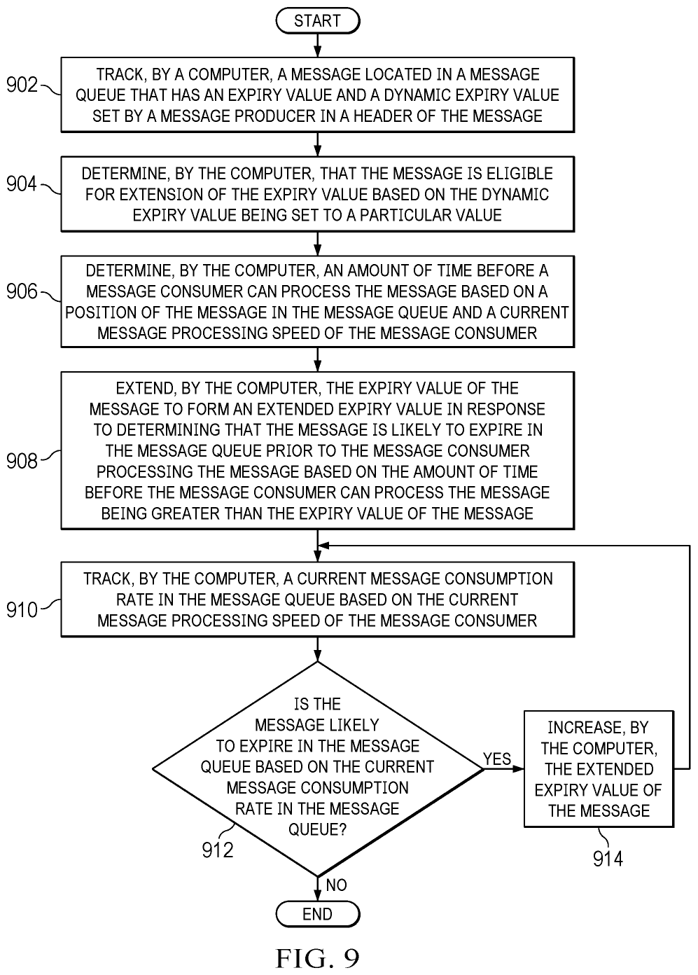

With reference now to FIG. 9, a flowchart illustrating a process for extending an expiry value of a message is shown in accordance with an illustrative embodiment. The process shown in FIG. 9 may be implemented in a computer, such as, for example, computer 101 in FIG. 1 or messaging server 202 in FIG. 2. For example, the process shown in FIG. 9 may be implemented in message expiry management code 200 in FIG. 1.

The process begins when the computer tracks a message located in a message queue that has an expiry value and a dynamic expiry value set by a message producer in a header of the message (step 902). The computer determines that the message is eligible for extension of the expiry value based on the dynamic expiry value being set to a particular value (e.g., the particular value being set to one (1)) (step 904). The computer also determines an amount of time before a message consumer can process the message based on a position of the message in the message queue and a current message processing speed of the message consumer (step 906).

The computer extends the expiry value of the message to form an extended expiry value in response to determining that the message is likely to expire in the message queue prior to the message consumer processing the message based on the amount of time before the message consumer can process the message being greater than the expiry value of the message (step 908). Further, the computer tracks a current message consumption rate in the message queue based on the current message processing speed of the message consumer (step 910).

The computer makes a determination as to whether the message is likely to expire in the message queue based on the current message consumption rate in the message queue (step 912). If the computer determines that the message is likely to expire in the message queue based on the current message consumption rate in the message queue, yes output of step 912, then the computer increases the extended expiry value of the message (step 914). Thereafter, the process returns to step 910 where the computer continues to track the current message consumption rate in the message queue. If the computer determines that the message is not likely to expire in the message queue based on the current message consumption rate in the message queue, no output of step 912, then the process terminates thereafter.

Thus, illustrative embodiments of the present invention provide a computer-implemented method, computer system, and computer program product for dynamically controlling message expiry in a message queue managed by a messaging server. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamically controlling message expiry, the computer-implemented method comprising:
tracking, by a computer, a message located in a message queue that has an expiry value and a dynamic expiry value set by a message producer in a header of the message;
determining, by the computer, that the message is eligible for extension of the expiry value based on the dynamic expiry value being set to a particular value;
determining, by the computer, an amount of time before a message consumer can process the message based on one or more factors; and
extending, by the computer, the expiry value of the message to form an extended expiry value in response to determining that the message is likely to expire in the message queue prior to the message consumer processing the message based on the one or more factors.

2. The computer-implemented method of claim 1 further comprising:
tracking, by the computer, a current message consumption rate in the message queue based on a current message processing speed of the message consumer;
determining, by the computer, whether the message is likely to expire in the message queue based on the current message consumption rate in the message queue; and
responsive to the computer determining that the message is likely to expire in the message queue based on the current message consumption rate in the message queue, increasing, by the computer, the extended expiry value of the message.

3. The computer-implemented method of claim 1 further comprising:
performing, by the computer, a scan of the message queue in response to a set of messages being placed in the message queue by the message producer via a network; and
generating, by the computer, a list of messages having the expiry value and the dynamic expiry value set in the header of a corresponding message in the set of messages located in the message queue based on the scan of the message queue.

4. The computer-implemented method of claim 3 further comprising:
identifying, by the computer, the expiry value of each respective message in the list of messages having expiry values; and
ranking, by the computer, each respective message in the list of messages having expiry values in ascending order from longest message expiry on bottom of the list to shortest message expiry on top of the list based on the expiry value of each respective message in the list to form a ranked list of messages.

5. The computer-implemented method of claim 4 further comprising:
determining, by the computer, whether the dynamic expiry value is set to one in the header of the message;
responsive to the computer determining that the dynamic expiry value is set to one in the header of the message, determining, by the computer, a remainder of the expiry value corresponding to the message; and
determining, by the computer, the amount of time before the message consumer can process the message off the message queue based on a plurality of factors.

6. The computer-implemented method of claim 5 further comprising:
determining, by the computer, a standard deviation value corresponding to a message processing speed of the message consumer at this point in time; and
adding, by the computer, the standard deviation value corresponding to the message processing speed of the message consumer at this point in time to the amount of time before the message consumer can process the message to form a standard deviation adjusted amount of time before the message consumer can process the message.

7. The computer-implemented method of claim 6 further comprising:
determining, by the computer, whether the standard deviation adjusted amount of time before the message consumer can process the message is greater than the remainder of the expiry value corresponding to the message;
responsive to the computer determining that the standard deviation adjusted amount of time before the message consumer can process the message is greater than the remainder of the expiry value corresponding to the message, utilizing, by the computer, the standard deviation adjusted amount of time before the message consumer can process the message as an extended expiry value for the message; and
setting, by the computer, the extended expiry value of the standard deviation adjusted amount of time before the message consumer can process the message in the header of the message.

8. The computer-implemented method of claim 1, wherein the one or more factors include at least one of number of messages in the message queue, position of each respective message within the message queue, number of messages processed per second by the message consumer, standard deviation corresponding to the message consumer at this point in time, average size of messages in the message queue, put and get rates in and out of the message queue, and set priority level of each respective message in the message queue.

9. A computer system for dynamically controlling message expiry, the computer system comprising:
a communication fabric;
a storage device connected to the communication fabric, wherein the storage device stores program instructions; and
a processor connected to the communication fabric, wherein the processor executes the program instructions to:
track a message located in a message queue that has an expiry value and a dynamic expiry value set by a message producer in a header of the message;
determine that the message is eligible for extension of the expiry value based on the dynamic expiry value being set to a particular value;
determine an amount of time before a message consumer can process the message based on one or more factors; and
extend the expiry value of the message to form an extended expiry value in response to determining that the message is likely to expire in the message queue prior to the message consumer processing the message based on the one or more factors.

10. The computer system of claim 9, wherein the processor further executes the program instructions to:
track a current message consumption rate in the message queue based on a current message processing speed of the message consumer;
determine whether the message is likely to expire in the message queue based on the current message consumption rate in the message queue; and
increase the extended expiry value of the message in response to determining that the message is likely to expire in the message queue based on the current message consumption rate in the message queue.

11. The computer system of claim 9, wherein the processor further executes the program instructions to:
perform a scan of the message queue in response to a set of messages being placed in the message queue by the message producer via a network; and
generate a list of messages having the expiry value and the dynamic expiry value set in the header of a corresponding message in the set of messages located in the message queue based on the scan of the message queue.

12. The computer system of claim 11, wherein the processor further executes the program instructions to:
identify the expiry value of each respective message in the list of messages having expiry values; and
rank each respective message in the list of messages having expiry values in ascending order from longest message expiry on bottom of the list to shortest message expiry on top of the list based on the expiry value of each respective message in the list to form a ranked list of messages.

13. The computer system of claim 12, wherein the processor further executes the program instructions to:
determine whether the dynamic expiry value is set to one in the header of the message;
determine a remainder of the expiry value corresponding to the message in response to determining that the dynamic expiry value is set to one in the header of the message; and
determine the amount of time before the message consumer can process the message off the message queue based on a plurality of factors.

14. A computer program product for dynamically controlling message expiry, the computer program product comprising a computer-readable storage medium having program instructions embodied therewith, the program instructions executable by a computer to cause the computer to perform a method of:
tracking, by the computer, a message located in a message queue that has an expiry value and a dynamic expiry value set by a message producer in a header of the message;
determining, by the computer, that the message is eligible for extension of the expiry value based on the dynamic expiry value being set to a particular value;
determining, by the computer, an amount of time before a message consumer can process the message based on one or more factors; and
extending, by the computer, the expiry value of the message to form an extended expiry value in response to determining that the message is likely to expire in the message queue prior to the message consumer processing the message based on the one or more factors.

15. The computer program product of claim 14 further comprising:
tracking, by the computer, a current message consumption rate in the message queue based on a current message processing speed of the message consumer;
determining, by the computer, whether the message is likely to expire in the message queue based on the current message consumption rate in the message queue; and
responsive to the computer determining that the message is likely to expire in the message queue based on the current message consumption rate in the message queue, increasing, by the computer, the extended expiry value of the message.

16. The computer program product of claim 14 further comprising:
performing, by the computer, a scan of the message queue in response to a set of messages being placed in the message queue by the message producer via a network; and
generating, by the computer, a list of messages having the expiry value and the dynamic expiry value set in the header of a corresponding message in the set of messages located in the message queue based on the scan of the message queue.

17. The computer program product of claim 16 further comprising:
identifying, by the computer, the expiry value of each respective message in the list of messages having expiry values; and
ranking, by the computer, each respective message in the list of messages having expiry values in ascending order from longest message expiry on bottom of the list to shortest message expiry on top of the list based on the expiry value of each respective message in the list to form a ranked list of messages.

18. The computer program product of claim 17 further comprising:
determining, by the computer, whether the dynamic expiry value is set to one in the header of the message;
responsive to the computer determining that the dynamic expiry value is set to one in the header of the message, determining, by the computer, a remainder of the expiry value corresponding to the message; and
determining, by the computer, the amount of time before the message consumer can process the message off the message queue based on a plurality of factors.

19. The computer program product of claim 18 further comprising:
determining, by the computer, a standard deviation value corresponding to a message processing speed of the message consumer at this point in time; and
adding, by the computer, the standard deviation value corresponding to the message processing speed of the message consumer at this point in time to the amount of time before the message consumer can process the message to form a standard deviation adjusted amount of time before the message consumer can process the message.

20. The computer program product of claim 19 further comprising:
determining, by the computer, whether the standard deviation adjusted amount of time before the message consumer can process the message is greater than the remainder of the expiry value corresponding to the message;
responsive to the computer determining that the standard deviation adjusted amount of time before the message consumer can process the message is greater than the remainder of the expiry value corresponding to the message, utilizing, by the computer, the standard deviation adjusted amount of time before the message consumer can process the message as an extended expiry value for the message; and
setting, by the computer, the extended expiry value of the standard deviation adjusted amount of time before the message consumer can process the message in the header of the message.
